(19) United States
(12) Patent Application Publication
(10) Pub. No.: US 2005/0094672 A1
(43) Pub. Date: May 5, 2005

(54) Mobile communication terminal, wireless communication system and method of previewing a moving image

(75) Inventor: Bum-Jin Jung, Seoul (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Ichon-Si (KR)

(21) Appl. No.: 10/781,713

(22) Filed: Feb. 20, 2004

(30) Foreign Application Priority Data
Oct. 30, 2003 (KR) 10-2003-0076504

(51) Int. Cl. H04J 1/00

(52) U.S. Cl. 370/486; 370/352

(57) ABSTRACT

A mobile communication terminal capable of providing an improved preview facility for moving image contents service over wireless Internet and a method for controlling the same are disclosed. The mobile communication terminal receives moving image file information for the moving image contents from the contents service server, transmits moving image preview request for the moving image contents to the contents service server, and then receives a preview image for previewing the moving image contents.

### BACKGROUND OF THE INVENTION

1. Field of the Invention

The present invention relates to a mobile communication terminal and more particularly to a mobile communication terminal having a function for previewing moving images via a wireless communication system and a moving image preview method of the same.

2. Description of the Related Art

In recent times, due to the current trend of rapidly developing mobile communication technology, many mobile communication terminal manufacturers have conducted intensive research into a new terminal which has functions capable of accessing the Internet, downloading multimedia contents (e.g., color photos, animation, moving images, music, or text data, etc.), storing and reproducing the multimedia contents, as well as a traditional voice or text data exchange function. Moreover, in order to provide such multimedia contents services, mobile communication service providers have constructed a network capable of establishing a communication protocol both between a terminal and a Web server and between mobile communication terminals to support packet switching of the multimedia contents.

FIG. 1 is a schematic block diagram illustrating a conventional multimedia contents service system using the wireless Internet. FIG. 2 is a conceptual diagram illustrating a conventional method for selecting a multimedia contents service over the Internet.

Referring to FIG. 1, it is preferable for a mobile communication terminal 10 to be designed to receive a wireless Internet service using a WAP protocol. Current mobile communication terminal manufacturers provide users or subscribers with terminals for supporting such a wireless Internet service.

A mobile communication network 20 is adapted to establish communication channels between mobile terminals, such that it performs a variety of functions, for example, a function for tracking a position of a mobile terminal, a function for determining a base station to which a communication channel is to be established, etc. The mobile communication network 20 also includes a circuit switched network (not shown) and a packet switched network (not shown), such that it provides a user with a voice communication service over the circuit switched network, and provides the user with multimedia data over the packet switched network. In more detail, the packet switched network includes a packet processor for processing error control and routing functions of input packet data, and a packet gateway connected to a contents service server 30 for transmitting/receiving a variety of contents over the Internet. The packet gateway provides a translation of the user traffic on a data call between the Internet standard protocol supported by the contents service server 30 and the WAP protocol supported by the mobile communication terminal 10 and the mobile communication network 20, such that the mobile communication terminal 10 can display various data provided from the contents service server 30, for example, E-mail, moving images, and music video data, etc.

The contents service server 30 is connected to contents providers 51 and 52 to provide users with a variety of contents such as movies, drama, and game contents, etc. Usually, there are a plurality of contents service servers 30, each of which may separately be managed and administered by different mobile communication service providers. Presently, individual contents service servers of the mobile communication service providers are interoperable with each other in such a way that a multimedia contents service can be performed between mobile communication terminals of different mobile communication service providers.

Referring to FIG. 2, when a user starts a wireless Internet service \mathring{4} to receive desired contents from the contents service server 30 of FIG. 1, the mobile communication terminal transmits an Internet access request signal to the mobile communication network 20. When the mobile communication terminal gains access to the contents service server over the mobile communication network, a variety of contents options are displayed, for example, E-mail/chatting contents \mathring{1}, and music/movie/other image contents \mathring{2}, etc. When the user selects movie contents from the contents \mathring{2}, the mobile communication terminal displays the list of movies stored in the contents service server. When the mobile communication terminal selects a specific movie “Terminator 3” among movies stored in the movie contents, a demo-movie of “Terminator 3” prepared by the corresponding contents provider is downloaded from the contents service server to be displayed on a screen of a mobile communication terminal. When the user is satisfied with the demo-movie and finally selects the content, the whole movie file of “Terminator 3” is downloaded from the contents service server and is reproduced on the mobile communication terminal.

However, as the number of contents providers and also the number of contents they provide are both rapidly increasing, this conventional selection method is very inefficient in that it involves downloading separate demo-image files having considerable volume and running time, regardless of the volume of original contents file.

Consequently, there is an urgent need for a method of efficiently showing to users a substance of a selected moving image before the users download the moving image.

### SUMMARY OF THE INVENTION

It is an object of the present invention to provide a mobile communication terminal through which a user can preview a substance of a moving image via a wireless communication system.

It is another object of the present invention to provide a method of previewing a substance of a moving image on a wireless Internet.

In accordance with the present invention, the above and other objects can be accomplished by the provision of a mobile communication terminal apparatus connected to a wireless Internet over a mobile communication network to receive a moving image associated contents service from a contents service server, comprising a communication unit for transmitting/receiving a data signal over the mobile communication network, a key input unit for receiving an operation command of a user, a contents receiver for receiving a contents file from the contents service server via the communication unit, a contents reproduction unit for reproducing contents received from the contents receiver, and outputting the reproduced content, a contents output unit for converting output data of the contents reproduction unit into a user-recognizable signal, and a moving image preview processor for transmitting moving image preview request data to the contents service server, and then receiving a preview image for previewing contents to be reproduced.

According to the above aspect of the present invention, the mobile communication terminal determines the preview method from among possible preview methods, and informs the contents service server of the determined method by sending moving image preview request data.

The preview method can be determined according to the processing capacity of each terminal, or the characteristics of the selected content. Hence, more efficient and less time consuming contents selection is possible by provision of mobile communication terminal of the present invention.

Further, according to the another aspect of the present invention, the moving image preview processor further includes a file information receiver for receiving moving image file information, for example, information containing a category, size, and compression ratio of the moving image file, from the contents service server and outputting the information to the user.

Therefore, the user of the mobile communication terminal can determine appropriate preview method upon receiving the useful file information prepared by the respective contents providers. Hence a mobile communication service provider and a manufacturer of such a mobile communication terminal can enhance a QoS (Quality of Service) of a moving image associated contents service over the wireless Internet, and the terminal user can acquire more accurate moving image information in response to his or her interests because he or she previews for his or her desired moving image content.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram illustrating a conventional multimedia contents service system using the wireless Internet;

FIG. 2 is a conceptual diagram illustrating a conventional method for controlling a mobile communication terminal to select a multimedia contents service over the Internet;

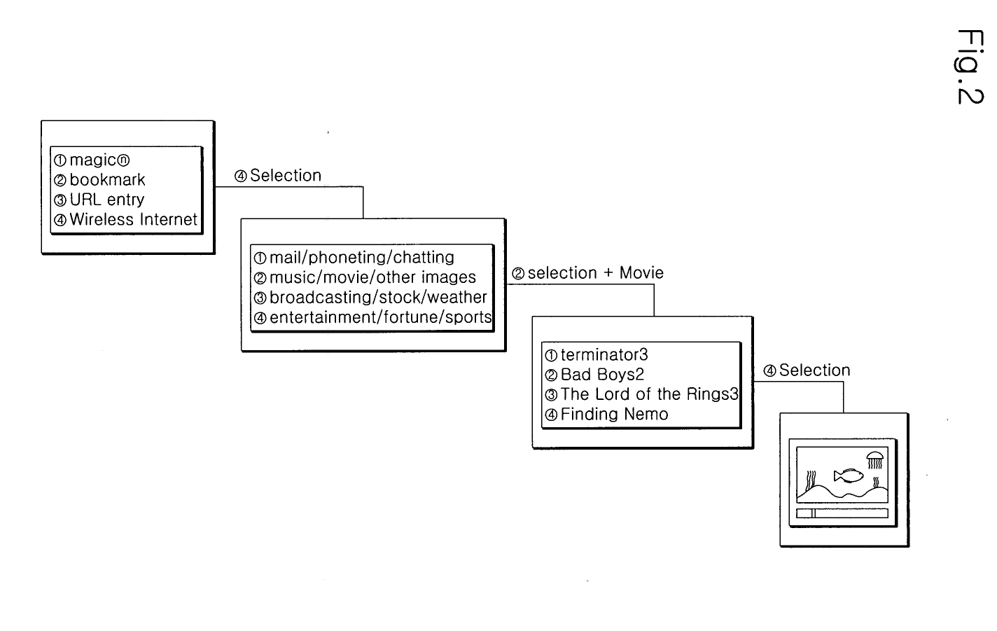

FIG. 3 is a schematic block diagram illustrating a mobile communication terminal in accordance with a preferred embodiment of the present invention; and

FIG. 4 is a flow chart illustrating a method for controlling the mobile communication terminal to receive a moving image file from a contents service server in accordance with a preferred embodiment of the present invention.

### DESCRIPTION OF THE PREFERRED EMBODIMENTS

Now, preferred embodiments of the present invention will be described in detail with reference to the accompanying drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

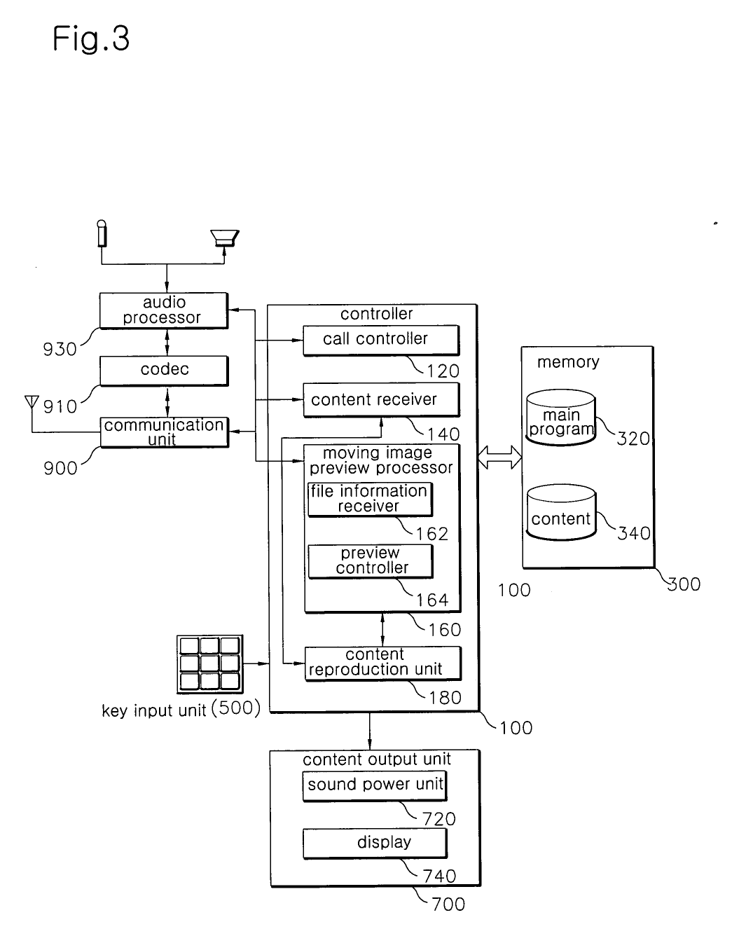

FIG. 3 is a schematic block diagram illustrating a mobile communication terminal in accordance with a preferred embodiment of the present invention.

Referring to FIG. 3, the mobile communication terminal includes a controller 100 for controlling a call connection operation and overall system operations, a memory 300 for storing various data composed of main program execution data and contents, a key input unit 500 for receiving a key command from a user, a contents output unit 700 for converting output data into a user-recognizable signal, and a communication unit 900 for transmitting/receiving a data signal over a mobile communication network.

For example, the controller 100 is implemented with a single microprocessor. However, it should be noted that the controller 100 for use in the present invention is not limited to only the single microprocessor, but can also be implemented with either two chips composed of a digital signal processor for physically processing multimedia signals and a system control microprocessor, or an integrated chip (IC) physically integrated in one package.

The memory 300 stores various data, including a main program execution file, associated static and/or dynamic data, and contents files. Physically, the memory 300 may consist of two or more nonvolatile memories, such as flash memories.

The key input unit 500 for receiving a user's command signal includes a plurality of digit keys 0˜9, a plurality of character keys, and a plurality of function keys. For example, the function keys may be composed of a call button, a text button, up and down arrow keys, a wireless Internet access key, volume up and down keys, and a variety of additional function selection keys, etc.

The contents output unit 700 includes a sound power unit 720 for converting digital audio data into a user-recognizable audio signal, and a display 740 for displaying a character or graphic data.

The communication unit 900 is a general mobile communication circuit containing an RF (Radio Frequency) circuit and a modulator/demodulator for processing a CDMA (Code Division Multiple Access) or GSM mobile communication protocol. For example, the communication unit 900 may include several RF circuits and a modulator/demodulator contained in a so called MSM (mobile Station Modem)-based chip manufactured by Qualcomm Corporation.

The components of block diagram shown in FIG. 3 are described here as logical blocks, and are not necessarily matched with corresponding physical blocks. For example, in one conventional embodiment, a codec (coder/decoder) 910, an audio processor 930, some parts of the communication unit 900, and a microprocessor serving as the controller 100 can be packaged in a single chip.

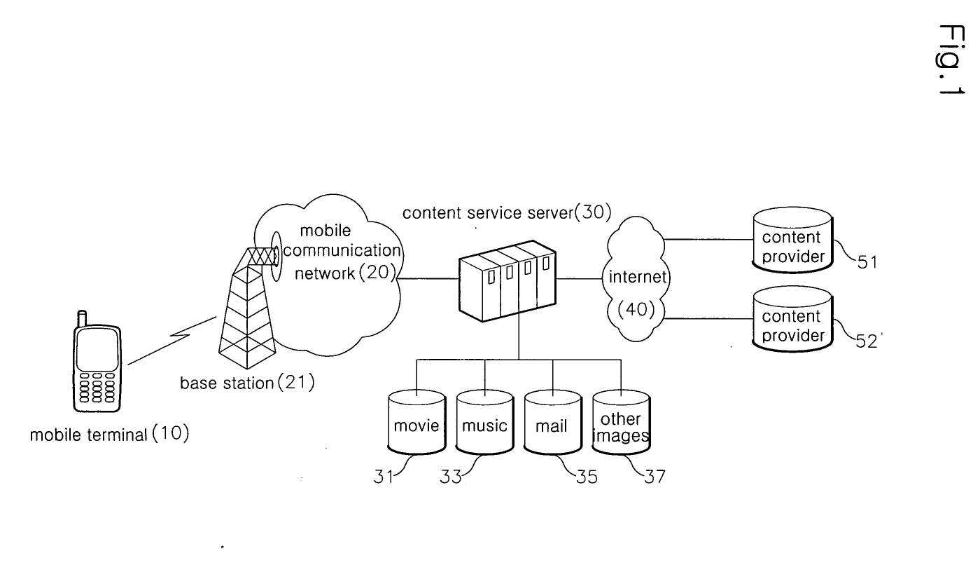

The controller 100 includes a call controller 120, and a contents receiver 140, a moving image preview processor 160, and a contents reproduction unit 180. The call controller 120 transmits a call origination signal to a mobile communication network via the communication unit 900 upon receiving a call connection request command from the key input unit 500. The contents receiver 140 receives a moving image file from the contents service server 30 shown in FIG. 1 via the communication unit 900 upon receiving a key operation command from the key input unit 500. The contents reproduction unit 180 reproduces contents received from the contents receiver 140, and outputs the reproduced contents. This reproduction processing may include decompression of audio and/or video signals, retrieving system data, or scaling of video data, etc. The contents output unit 700 converts the output data of the contents reproduction unit 180 into a user-recognizable signal. This conversion processing may include digital/analog converting, amplification, and filtering for audio signals. And for video signals, this processing includes driving a display panel according to the video data stored in video frame memory.

According to a distinctive feature of the present invention, the controller 100 further includes a moving image preview processor 160. The moving image preview processor 160 transmits a moving image preview request data to the contents service server, and then receives a preview image for previewing a contents to be reproduced.

The moving image preview processor 160 of the mobile communication terminal decides the appropriate preview method for itself based on the information it can reach. For example, the preview method can be determined based on the processing capacity of the mobile communication terminal, traffic condition of the network, file size or compression state of the target contents file, etc.

The preview method can be determined by the moving image preview processor 160 automatically. But according to another aspect of present invention, this can be determined manually by the user of the mobile communication terminal. These and other features of the present invention will be described in more detail below.

The moving image preview processor 160 may be implemented in the form of a program code to be executed by a microprocessor constituting the controller 100.

According to the one preferred embodiment of the present invention, the moving image preview processor 160 comprises a file information receiver 162 and a preview controller 164. The file information receiver receives moving image file information from the contents service server and outputs the moving image file information to the user. For example, the moving image file information may include a kind, a size and a compression ratio of the moving image. In this embodiment, the moving image file information received is displayed on the display 740 as a text data.

The preview controller 164 receives a moving image preview request command from the key input unit 500, and transmits moving image preview request data to the contents service server. Then, it receives a preview image for previewing content to be reproduced.

The preview controller also controls the preview operation of the received preview image. It outputs the received preview image to the contents reproduction unit 180 and monitors the key input unit 500 for user's command. The contents reproduction unit 180 reproduces the preview image and controls the reproduction operation according to the user's command inputted through the key input unit 500.

According to the preferred embodiment of the present invention, the preview image received from the contents service server is one of at least two types. The first type of the preview image includes a part of the target moving images having a predetermined running time. The second type of the preview image includes a plurality of still images generated from the target contents file.

In more detail, file information of a desired moving image received through the contents receiver 140 from the contents service server 30 is displayed on the display 740. Through the file information, a user can recognize the category of the moving image, for example, a movie, a drama, or a music video, etc and can also see a compression ratio. As a result, the user can determine an appropriate method of previewing a desired moving image. When a preview image has a running time of several to tens of seconds, it is better to request still images. But, when a compression ratio is high, it is better for users to request some portion of moving image as a preview image.

Upon receiving the moving image preview request data, the contents service server retrieves a corresponding preview image according to the preview request data received, and transmits the preview image to the mobile communication terminal. The mobile communication terminal reproduces the preview image and waits for another command for the preview image.

Now, a method for previewing a moving image in a mobile communication terminal apparatus connected to a wireless Internet over a mobile communication network to receive a moving image associated contents service from a contents service server is described.

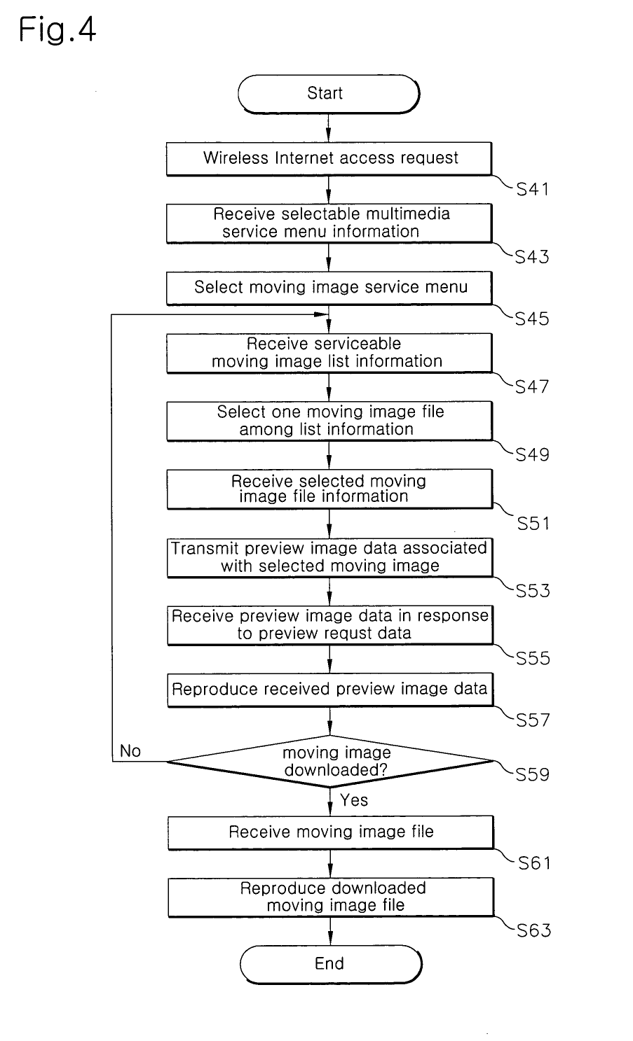

FIG. 4 is a flow chart illustrating a method for previewing a moving image on a wireless Internet in accordance with a preferred embodiment of the present invention. Referring to FIG. 4, in order to use a desired moving image contents, a wireless Internet access request signal is transmitted to the mobile communication network 20 in response to a key operation signal of a terminal user at step S41.

After establishing a wireless Internet connection between the requested terminal and a main contents service server 30 of FIG. 1, selectable multimedia service menu information is transmitted to the terminal and displayed on the display 740 of the terminal at step S43. A moving image service menu selection command is inputted and transmitted to the contents service server 30 of FIG. 1 at step S45.

After that, a serviceable moving image list information is received from the contents service server 30 in FIG. 1 and displayed on the display 740 at step S47. A moving image file selection command is inputted from the user of the mobile communication terminal upon presenting the received list information, and then the inputted command is transmitted to the contents service server 30 at step S49.

The contents service server 30 transmits the information of a desired moving image file to the mobile communication terminal at step 51. As described before, the moving image file information may include a kind, a size and a compression ratio or degree of the moving image. The mobile communication terminal receives and displays the selected moving image file information on the display 740 at step S51.

After that, the user selects a desired preview method with reference to the file information and transmits a moving image preview request data to the contents service server 30 at step S53.

But according to the another aspect of the present invention, the moving image preview request data which the moving image preview processor transmits can be generated automatically by a program code loaded and executed by the mobile communication terminal according to the received moving image file information.

Therefore, moving image preview data, i.e., a preview moving image having a predetermined running length or still images is received from the contents service server 30 at step S55. Then, the moving image preview data is reproduced or displayed through the sound power unit 720 and the display 740 at step 57.

A user who has previewed a desired moving image determines whether to download the moving image at step 59. When a download request command is inputted at step S59, the corresponding moving image file is downloaded from the contents service server 30 at step S61. Then the received moving image file is reproduced or displayed through the sound power unit 720 and the display 740 at step S63. Otherwise, if a user selects not to download at step S59, serviceable moving image list information is received from the contents service server 30 to be displayed on the display 740 at step S47, such that a user can receive a new moving image service from the contents service server 30.

As described herein before, a mobile communication terminal according to the present invention provides a function that a user can efficiently preview desired moving image content having a long running time, e.g., a movie, a drama, and a music video, etc. during a short time in the case of using a multimedia contents service over the wireless internet.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A mobile communication terminal, comprising:
a contents receiver for receiving moving image contents from a contents service server;
a contents reproduction unit for reproducing the moving image contents received from the contents receiver;
a contents output unit for converting the reproduced moving image contents into a user-recognizable signal; and
a moving image preview processor for receiving moving image file information for the moving image contents from the contents service server, transmitting a moving image preview request for the moving image contents to the contents service server, and then receiving a preview image for previewing the moving image contents.

2. The apparatus as set forth in claim 1, wherein the moving image file information includes a size or a compression ratio of the moving image contents.

3. The apparatus as set forth in claim 2, wherein the preview image includes a plurality of still images which are part of the moving image contents.

4. The apparatus as set forth in claim 1, wherein the preview image is a moving image having a predetermined running time which is a part of the moving image contents.

5. A wireless communication system, comprising:
a contents service server for providing moving image contents, a preview image for the moving image contents and moving image file information for the moving image contents; and
a mobile communication terminal for transmitting a moving image preview request according to the moving image file information from the contents service server to receive the preview image for previewing the moving image contents.

6. The wireless communication system as set forth in claim 5, wherein the moving image file information includes a size or a compression ratio of the moving image contents.

7. The wireless communication system as set forth in claim 5, wherein the preview image is a moving image having a predetermined running time which is a part of the moving image contents.

8. The wireless communication system as set forth in claim 5, wherein the preview image includes a plurality of still images which are part of the moving image contents.

9. A method for previewing a moving image in a mobile communication terminal apparatus, comprising the steps of:
a) selecting a moving image and receiving moving image file information for the moving image from a contents service server;
b) transmitting a moving image preview request according to the moving image file information to the contents service server; and
c) receiving a preview image transmitted in response to the moving image preview request from the contents service server.

10. The method as set forth in claim 9, wherein the moving image file information includes a size or a compression ratio of the moving image contents.

11. The method as set forth in claim 9, wherein the preview image is a moving image having a predetermined running time which is a part of the moving image contents.

12. The method as set forth in claim 9, wherein the preview image includes a plurality of still images which are part of the moving image contents.

13. A contents servicing method executable by a contents service server connected to a plurality of mobile communication terminals over a mobile communication network, comprising the steps of:
transmitting moving image file information for moving image contents to a mobile communication terminal;
receiving a moving image preview request for the moving image contents from the mobile communication terminal; and
transmitting a preview image for previewing the moving image contents to the mobile communication terminal conforming to the moving image preview request.

14. The method as set forth in claim 13, wherein the moving image file information includes a size or a compression ratio of the moving image contents.

15. The method as set forth in claim 13, wherein the preview image is a moving image having a predetermined running time which is a part of the moving image contents.

16. The method as set forth in claim 13, wherein the preview image includes a plurality of still images which are part of the moving image contents.
